(19) United States
(12) Patent Application Publication
(10) Pub. No.: US 2006/0185183 A1
(43) Pub. Date: Aug. 24, 2006

(54) Adjustable sizing device

(75) Inventors: Henning Stieglitz, Munchen (DE); Aron Altmann, Dachau (DE)

Correspondence Address: Henry M. Feiereisen;Henry M. Feiereisen, LLC, Suite 4714, 350 Fifth Avenue, New York, NY, 10118, US

(73) Assignee: Krauss-Maffei Kunststofftechnik GmbH, Munchen (DE)

(21) Appl. No.: 11/353,704

(22) Filed: Feb. 14, 2006

Related U.S. Application Data
(63) Continuation of application No. PCT/EP04/07411, filed on Jul. 7, 2004.

(30) Foreign Application Priority Data
Aug. 14, 2003 (DE) 103 37 533.3

(51) Int. Cl. G01B 3/10

(52) U.S. Cl. 33/555.4

(57) ABSTRACT

An adjustable sizing device for sizing extruded continuous profiles, in particular tubes, includes a plurality of segment bodies disposed about a circle and having a plurality of slats for defining with their radially inner ends a common sizing opening. The segment bodies are held and adjusted in radial direction by actuators to thereby allow change in dimension of the sizing opening, wherein each of the segment bodies is operatively connected to at least one of the actuators. The actuators are received and aligned in at least one mounting ring which has a number of radial bores spaced from one another in circumferential direction at a number corresponding to a number of segment bodies.

### CROSS-REFERENCES TO RELATED APPLICATIONS

This application is a continuation of prior filed copending PCT International application no. PCT/EP2004/007411, filed Jul. 7, 2004, which designated the United States and on which priority is claimed under 35 U.S.C. §120 and which claims the priority of German Patent Application, Serial No. 103 37 533.3, filed Aug. 14, 2003, pursuant to 35 U.S.C. 119(a)-(d), the contents of which are incorporated herein by reference.

### BACKGROUND OF THE INVENTION

The present invention relates, in general, to an adjustable sizing device for sizing extruded continuous profiles, e.g. tubes.

Nothing in the following discussion of the state of the art is to be construed as an admission of prior art.

Sizing devices of a type involved here are used for example for maintaining the dimension of continuous profiles which have been extruded in an extruder. Plastic melt is initially plasticized in the extruder and suitably shaped, when advancing through an exit nozzle, also called die. The desired dimension of the continuous profile is ensured by passing the profile through the sizing device, where it is formed to or held at precise dimension.

The production of plastic tubes of different wall thicknesses or outer diameters required heretofore the need for several different sizing devices. A change in the tube production thus made it necessary to not only replace the dies but also the sizing devices. Thus, downtimes in the production were experienced.

German Offenlegungsschrift DE 198 43 340 C2 describes an adjustable sizing device for use with tubes of different dimensions. The sizing device includes a plurality of slats arranged in circumferentially spaced-apart relationship on the outside of the tube being sized. A plurality of slat rings are arranged in a sizing station, as viewed in production direction of the tube, with the individual slats of ring-shaped slat blocks being spaced apart. Thus, the individual slats of individual blocks can be adjusted in relation to the slats of the next block or of the preceding block.

A conventional sizing device, also called sizing basket, is shown schematically in FIGS. 3 and 4 and generally designated by reference numeral 110. The sizing basket 110 includes 24 slats which are arranged in a generally tubular housing in circumferential direction thereof and held for radial adjustment so that the sizing basket 110 can be adjusted for use with tubes of different diameters by moving the slat blocks radially inwards or radially outwards. FIG. 3 shows on the left-hand side and on the right-hand side different adjustments for two different tube diameters. Of course, this is done for illustrative purposes only in actual operation, the sizing device handles only one tube diameter at one time.

Each slat has two actuators 112 disposed in axially spaced-apart relationship and accommodated in the housing. The actuators 112 include a threaded sleeve and a threaded rod received in the threaded sleeve and clamped together with the threaded sleeve by bolts. As shown in FIG. 4, a driving wheel 136 is rotatably arranged in coaxial relationship between the two rows of actuators 112. The driving wheel 136 has a side thread to mesh with threaded nuts on the actuators 112 for radial adjustment of the slats.

Conventional sizing devices are complicated in structure and composed of many parts that need to be assembled so that their manufacture is complex and cost-intensive. In order to maintain the actuators 112 in position, numerous retention structures are required. As shown in FIG. 4, there is need for arrangement of a first retention ring 140, a second retention ring 142, a sleeve-like inner retention ring 150 and a lateral retention ring 160. All these components together with other elements make up the substantially tubular housing.

It would therefore be desirable and advantageous to provide an improved sizing device which obviates prior art shortcomings and which is easy to assemble and cost-efficient while still being reliable in operation.

### SUMMARY OF THE INVENTION

According to one aspect of the present invention, an adjustable sizing device for sizing extruded continuous profiles, in particular tubes, includes a plurality of segment bodies disposed about a circle and having a plurality of slats for defining with their radially inner ends a common sizing opening, a plurality of actuators for holding the segment bodies and adjustment of the segment bodies in radial direction to thereby allow change in dimension of the sizing opening, wherein each of the segment bodies is operatively connected to at least one of said actuators, and at least one mounting ring having a number of radial bores spaced from one another in circumferential direction at a number corresponding to a number of segment bodies for receiving and aligning the actuators.

The present invention resolves prior art problems by providing a mounting ring whose purpose is essentially to retain the segment bodies so that the need for a great number of additional assembly elements and the need for many housing parts to form a sizing device are eliminated. The mounting ring is easy and inexpensively to make and allows easy installation of the actuators.

According to another feature of the present invention, the actuators may each be constructed in the form of a spindle drive. The spindle drive may include a nut and a threaded shaft which is moved by the nut radially outwards or inwards. As an alternative, the spindle drive may also be constructed with a threaded sleeve and a threaded rod which is received in the threaded sleeve and constructed for attachment of the segment body. The threaded sleeve may be received in the mounting ring or in a separate receptacle. The threaded rod can subsequently be placed in the threaded sleeve. Although, the use of a spindle drive for an actuator is currently preferred, there are many other constructions applicable to realize the actuation, e.g. hydraulic or electric drives.

According to another feature of the present invention, a second such mounting ring may be provided, wherein the two mounting rings are arranged in coaxial and axially spaced-apart relationship, with the segment bodies being held in each of the mounting rings. Each segment body then includes two actuators, which are respectively received in associated openings of the mounting rings.

According to another feature of the present invention, the mounting rings may be secured to a common structure, e.g. an inner support and retention ring, to maintain the mounting rings in position relative to one another. Thus, the retention and thus a major part of the housing can then be formed by both mounting rings and the inner support and retention ring.

According to another feature of the present invention, a driving wheel may be rotatably held between the mounting rings in coaxial relationship for adjusting the spindle drives.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross section of a sizing device according to the present invention perpendicular to the longitudinal axis;

FIG. 2 is a longitudinal section of the sizing device;

FIG. 3 is a cross section of a prior art sizing device perpendicular to the longitudinal axis; and

FIG. 4 is a longitudinal section of the prior art sizing device of FIG. 3, taken along the line IV-IV in FIG. 3.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

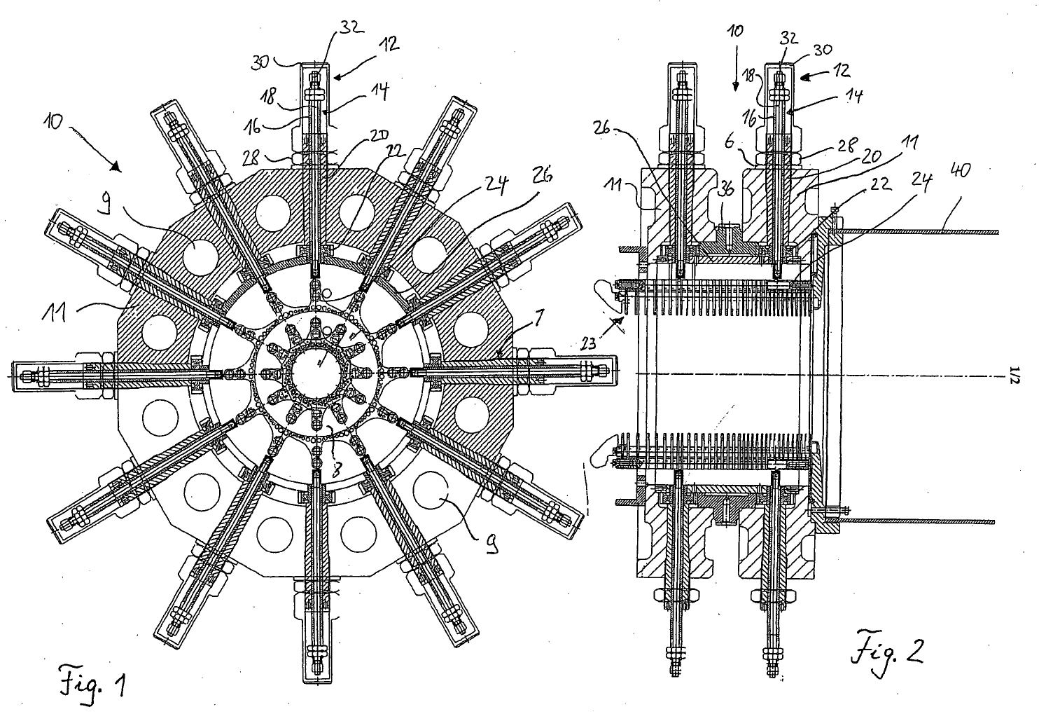

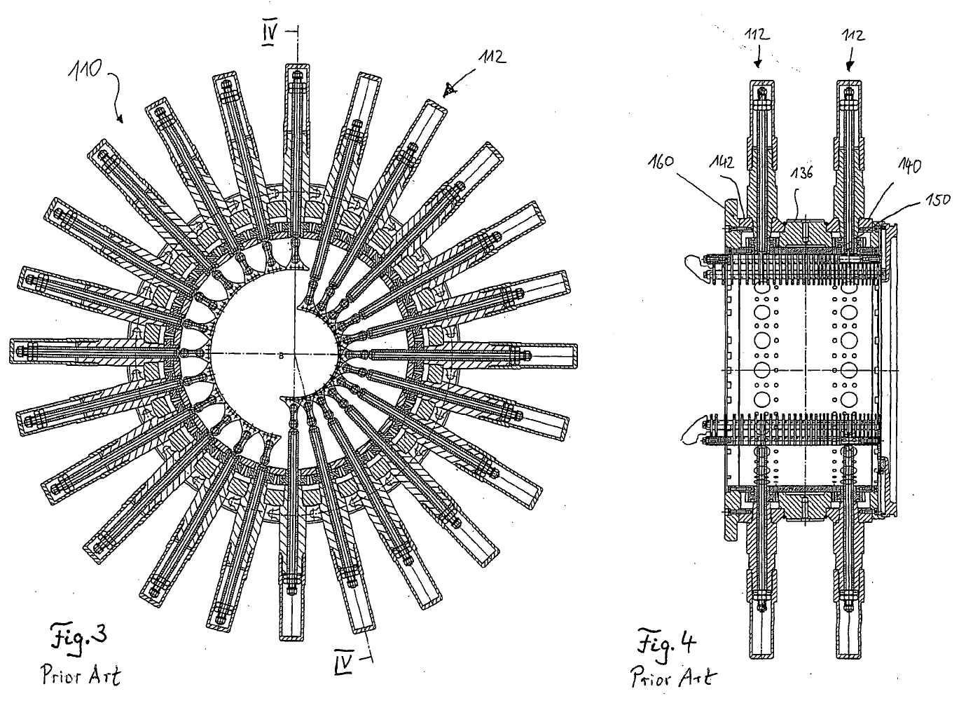

Turning now to the drawing, and in particular to FIG. 1, there is shown a cross section of a sizing device according to the present invention, generally designated by reference numeral 10. The sizing device 10 includes a plurality of segment bodies 23, which are arranged in a circle and at least partly overlap, with each of the segment bodies 23 having plural slats 24, for jointly demarcating a sizing opening 8 for sizing a tube. Each of the segment bodies 23 is movably supported by two actuators, generally designated by reference numeral 12, for shifting the slats 24 in radial direction to thereby conform the diameter of the sizing opening 8 to tubes of different diameter. For illustrative purposes only, FIG. 1 shows in the center a disposition of the slats 24 that have been shifted radially inwards for demarcating a sizing opening 8 of smaller size.

The actuators 12 are received in bores 7 of two mounting rings 11 which are disposed in axially spaced-apart and coaxial relationship, as shown in FIG. 2. In the non-limiting example of FIG. 1, the mounting rings 11 have each twelve bores 7 in spaced-apart circumferential direction, so that the sizing device 10 has a total of twenty-four actuators 12. Each actuator 12 includes a screw shaft 18 which is received in a sleeve 16 seated and held in a receptacle 20 which is fitted, e.g. screwed, in the corresponding bore 7 of the mounting ring 11. The slats 24 are secured to the radially inward end of the screw shafts 18, as shown in FIG. 2. Adjustment screws 32 are mounted to the slat-distal end of the screw shafts 18 for securing and adjustment of the screw shafts 18. To the outside, each actuator 12 is protected by an enclosing housing 30 and counternut 28 with underlying washer 6.

The sleeve 16 is provided at least in a lower area thereof with an outer thread for intermeshing engagement with a threaded nut 22. Depending on which way the nut 22 is turned, the sleeve 16 and thus the screw shaft 18 is moved radially inwards or outwards so as to adjust a radial position of the slats 24 accordingly.

As shown in FIG. 2, a common tubular support and retention ring 26 is provided radially inwards of the nuts 22 and connected to the mounting rings 11 via a suitable bolted connection (indicated by dashdot lines). The support and retention ring 26 thus rotatably receives and secures the twelve nuts 22 per mounting ring 11. In other words, the nuts 22 are secured between the support and retention ring 26 and the mounting rings 11, with the support and retention ring 26 maintaining a positional relationship between the mounting rings 11.

The sizing device 10 is operatively connected to a vacuum suction unit 40, shown only partially and schematically for sake of simplicity.

Placed coaxially between the mounting rings 11 is a driving wheel 36 having teeth on the side for respectively meshing with the nuts 22 of the left-hand actuators 12 and with the nuts 22 of the right-hand actuators 12. By turning the driving wheel 36 in circumferential direction of the sizing device 10, all twenty-four actuators 12 can be operated in synchronism at the same time so as to move all screw shafts 18 and thus the slats 24 of all segment bodies 23 radially inwards or outwards.

Thus, the sizing device 10 according to present invention includes in addition to the segment bodies 23 and actuators 12 substantially only the two mounting rings 11, the driving wheel 36 and the support and retention ring 26. The actuators 12 can easily be fitted in the receptacles 20 and braced. There is no need to assemble and secure a great number of separate housing parts. Manufacturing costs can therefore be reduced, and the overall assembly of a sizing device according to the present invention is greatly simplified. Suitably, as shown in FIG. 1, the mounting rings 11 are further provided with holes or recesses 9 for weight saving and material saving reasons so as to even further reduce manufacturing costs.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. An adjustable sizing device for sizing extruded continuous profiles, in particular tubes, comprising:
a plurality of segment bodies disposed about a circle and having a plurality of slats for defining with their radially inner ends a common sizing opening;
a plurality of actuators for holding the segment bodies and adjustment of the segment bodies in radial direction to thereby allow change in dimension of the sizing opening, wherein each of the segment bodies is operatively connected to at least one of said actuators; and
at least one mounting ring having a number of radial bores spaced from one another in circumferential direction at a number corresponding to a number of segment bodies for receiving and aligning the actuators.

2. The sizing device of claim 1, wherein the mounting ring has a plurality of receptacles for receiving the actuators, each of the receptacles placed in a corresponding one of the bores of the mounting ring for precise alignment, whereby the receptacles and the bores are placed into one-to-one correspondence.

3. The sizing device of claim 1, wherein each of the actuators has a spindle drive.

4. The sizing device of claim 3, wherein the spindle drive includes a threaded sleeve and a screw shaft received in the threaded sleeve and constructed for attachment of the segment body.

5. The sizing device of claim 1, further comprising a second said mounting ring, wherein the mounting rings are arranged in coaxial and axially spaced-apart relationship, with the segment bodies being held in each of the mounting rings.

6. The sizing device of claim 5, further comprising a driving wheel rotatably held between the mounting rings in coaxial relationship for adjusting the segment bodies.

7. The sizing device of claim 5, further comprising an inner support and retention ring arranged in coaxial relationship to the mounting rings and connected the mounting rings.

8. The sizing device of claim 7, further comprising a driving wheel rotatably held between the mounting rings in coaxial relationship for adjusting the segment bodies, and a threaded nut for each of the actuators, said threaded nut being rotatably disposed between the inner support and retention ring and the mounting rings and arranged in intermeshing engagement with the driving wheel.

9. The sizing device of claim 1, wherein the mounting ring is formed with holes for weight saving.
